(19) United States
(12) Patent Application Publication
(10) Pub. No.: US 2025/0139365 A1
(43) Pub. Date: May 1, 2025

(54) SYSTEM AND METHOD FOR EXPLOITING USER FEEDBACK TO DERIVE TRENDING TERMS AND APPLICATIONS THEREOF

(71) Applicant: YAHOO ASSETS LLC, New York, NY (US)

(72) Inventors: Donghyun Kim, Mountain View, CA (US); Liuqing Li, Santa Clara, CA (US); Xinyue Wang, San Jose, CA (US); Yufeng Ma, Santa Clara, CA (US); Rao Shen, Sunnyvale, CA (US)

(21) Appl. No.: 18/496,156

(22) Filed: Oct. 27, 2023

(51) Int. Cl. G06F 40/279; G06F 16/954

(52) U.S. Cl. CPC G06F 40/279; G06F 16/954

(57) ABSTRACT

The present teaching relates to trending term identification. Information in different categories from different sources associated with each of terms being evaluated for trendiness is obtained within a recent period and linked to generate a data group for each term. Features are extracted for each term based on information in the corresponding data group and are used to compute a trendiness score in accordance with a scoring model. Trending terms are selected from the terms based on their trendiness scores.

### BACKGROUND

### 1. Technical Field

The present teaching generally relates to electronic content processing. More specifically, the present teaching relates to online information processing.

### 2. Technical Background

With the development of the Internet and the ubiquitous network connections, more and more commercial and social activities are conducted online. Networked content is served to millions, some requested and some recommended. Such online content includes information such as publications, articles, and communications as well as advertisements. Online platforms that make electronic content available to users leverage the opportunities to provide content of users' likings to maximize the monetization of the platforms. FIG. 1A shows exemplary Internet services, including intelligence gathering, information dealers, and recommendation of content, which may include articles, advertisements, and activities or events. To offer desirable content to users, an important task is to recognize what is currently trending. For example, trending topics may be identified so that online content related to the trending topics may be identified. To make it easier for users to access content on trending topics, words representing corresponding trending topics may be provided as actionable links at a prominent position on a webpage so that users may simply click on the links to access such content at the fingertip. FIG. 1B provides an example webpage 100 with a section 110 at the upper-right corner on “Trending Now” providing a list of 10 words representing the currently trending topics, each of which is an actionable link which, once clicked, e.g., takes a clicking user to some online content source where content on the clicked trending topic may be provided.

Traditionally, a trending topic may be detected in different ways. For instance, a trending topic may be detected based on, e.g., a search log recording the search keywords used by users. The frequency in searches made in a time window identified in such a search log may reflect the degree of interests of users and thus may represent what is trending during the time window. Although the frequency of certain keywords used to search for content of a certain topic may be indicative of what is trending, trending topics embedded in content may not be accurately determined based on the frequency of usage of words during searches.

Thus, there is a need for a solution that can tackle the issue associated with the traditional approaches to enhance the performance of trending topic detection.

### SUMMARY

The teachings disclosed herein relate to methods, systems, and programming for information management. More particularly, the present teaching relates to methods, systems, and programming related to content processing and categorization.

In one example, a method, implemented on a machine having at least one processor, storage, and a communication platform capable of connecting to a network for trending term identification. Information in different categories from different sources associated with each of terms being evaluated for trendiness is obtained within a recent period and linked to generate a data group for each term. Features are extracted for each term based on information in the corresponding data group and are used to compute a trendiness score in accordance with a scoring model. Trending terms are selected from the terms based on their trendiness scores.

In a different example, a system is disclosed for trending term determination. A trending term determiner is provided for obtaining information of different categories from different sources associated with each of terms being evaluated for trendiness within a recent period. A data linking unit is provided to link information associated with each term to generate a data group for each term. A feature extractor is provided for extracting features for each term based on information in its corresponding data group. A term score determiner is provided to compute a trendiness score for each term based on its features in accordance with a scoring model. Trending terms are then selected from the terms based on their trendiness scores.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for trending term identification. When the information is read by the machine, it causes the machine to perform various steps. Information in different categories from different sources associated with each of terms being evaluated for trendiness is obtained within a recent period and linked to generate a data group for each term. Features are extracted for each term based on information in the corresponding data group and are used to compute a trendiness score in accordance with a scoring model. Trending terms are selected from the terms based on their trendiness scores.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates exemplary types of content related Internet services;

FIG. 1B shows an exemplary webpage with an area designated to trending topics and actionable links thereof;

FIG. 2A illustrates exemplary observations associated with conventional approach to determine trending terms;

FIG. 2B depicts an exemplary framework for identifying trending terms based on users' engagement on content, in accordance with an embodiment of the present teaching;

FIG. 3A shows exemplary types of information associated with a term that may be used for evaluation as to the trendiness of the term, in accordance with an embodiment of the present teaching;

FIG. 3B illustrates exemplary types of sources of search logs that may be explored for trending term detection, in accordance with an embodiment of the present teaching;

FIG. 4A illustrates exemplary content sources for content consumed by users that may be explored for trending term evaluation, in accordance with an embodiment of the present teaching;

FIG. 4B shows exemplary types of engagement metrics that may be collected and explored in trending term evaluation, in accordance with an embodiment of the present teaching;

FIG. 5A depicts an exemplary high-level system diagram of a trending term determiner, in accordance with an embodiment of the present teaching;

FIG. 5B illustrates exemplary types of features associated with a term that may be used in evaluating the trendiness of the term, in accordance with an embodiment of the present teaching;

FIG. 5C is a flowchart of an exemplary process of a trending term determiner, in accordance with an embodiment of the present teaching;

FIG. 6 depicts an exemplary high level system diagram of a scoring model training mechanism for adaptively updating a scoring model based on training data generated based on continually collected information, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses a framework for determining trending terms by overcoming shortcomings of the traditional approach to the same. Conventionally, trending terms are determined based on search logs which records the search conducted by users. Frequently searched terms as occurred in a specified window may be identified as trending terms based on the popularity exhibited recently. Although user search activities may be indicative of what users care about at the time of the search, other activities may also be, if not more, indicative of users' interests and focus during each period. In addition, the way users exhibit their interests in certain topics may not necessarily be exhibited via search activities. Given that, focusing only on search logs may not be able to capture the useful information that may be used to evaluate the interests or focus of users in content.

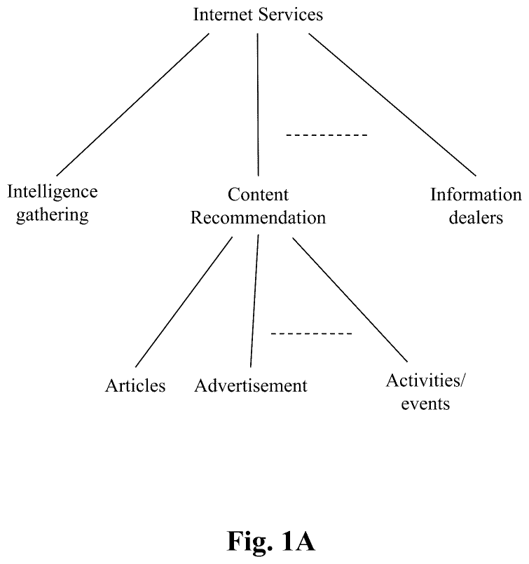

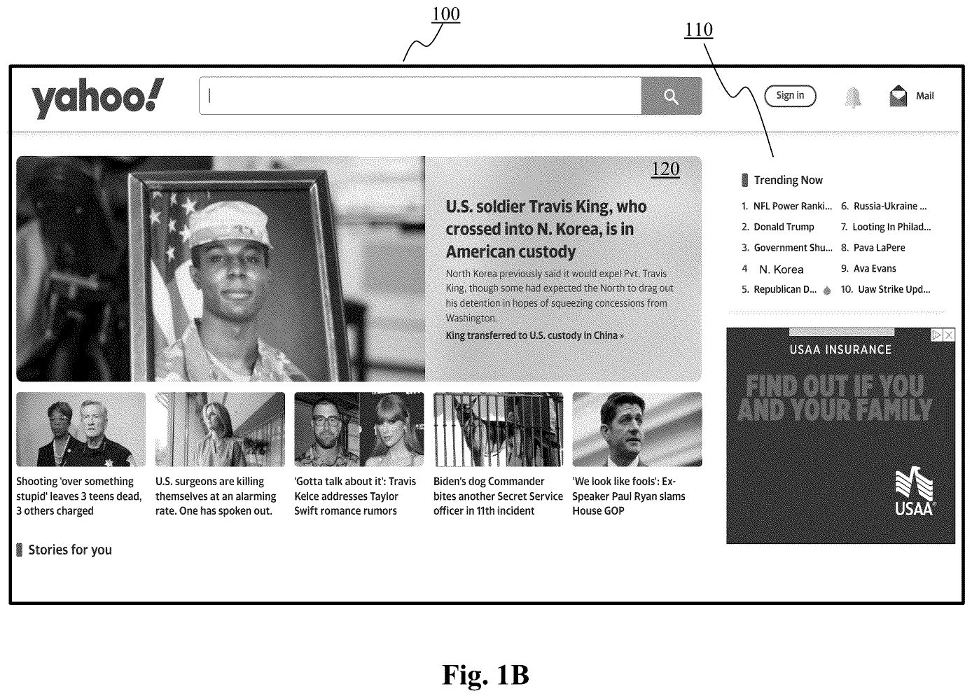

As shown in FIG. 1B, a front page of a website may include different sections, each of which provides different content to users. In that example, section 110 is a “Trending Now” part listing trending terms (10) which may be identified based on search logs. On the same page, there is a headline story section, providing actionable windows representing different headline stories which may be clicked by users to access the details of the stories. For example, the top headline story on this webpage is 120, corresponding a report that U.S. soldier Travis King who crossed into No. Korea is now in American custody. As can be seen in this example, word “N. Korea” appears in both the “Trending Now” section 110 and the top headline story 120. In this case, if a user clicks on the trending term “N. Korea” in section 110, such an action is considered as solidify the trendiness of the word “N. Korea.” However, if a user clicks directly on the top headline story 120, although the user exhibits the same interest on the same topic, as there is no click on the trending term or no search activity using that word involved, the user's interest on content related to N. Korea may not be used in trending term detection.

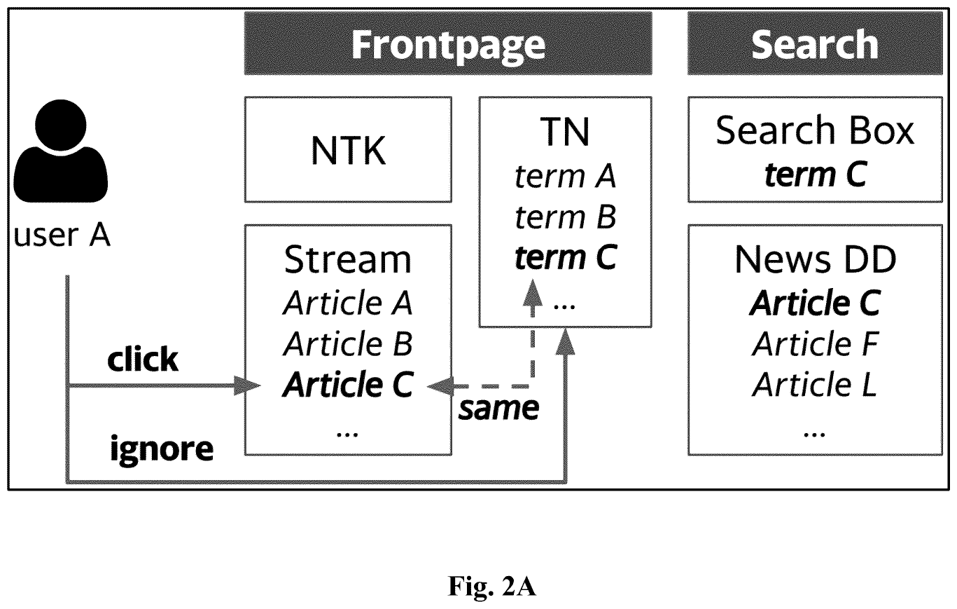

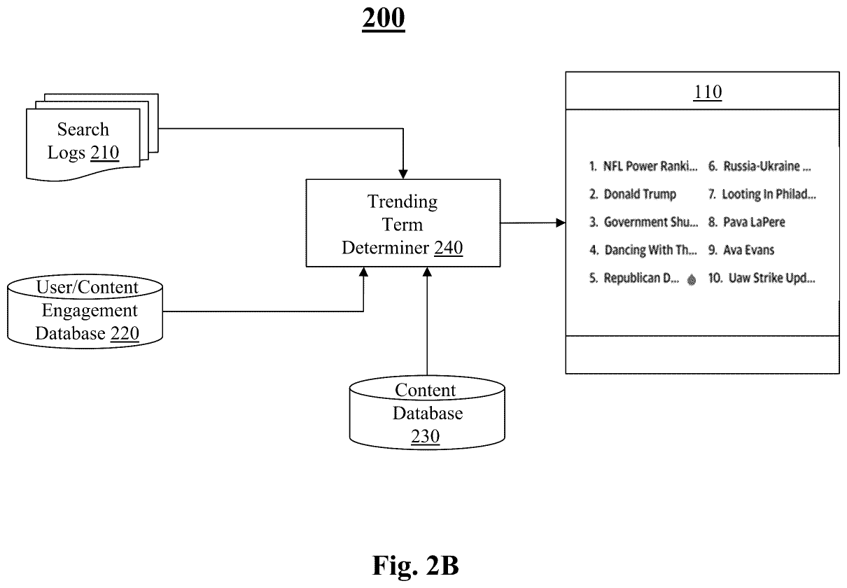

FIG. 2A illustrates exemplary observations associated with conventional approach to determine trending terms. A webpage may generally include multiple sections, including a search section, a need to know (NTK) section, a trending now (TN) section, a news section, and a stream section. Each section on the same page may list multiple items, each of which represents a choice and may be actionable, i.e., a user may click on it to access the corresponding content. Different pieces of content accessible via items listed in different sections may correspond to the same topics, as seen in FIG. 1B on “N. Korea”. FIG. 2A shows the same, e.g., TN section includes a trending term C, which may correspond to some topic such as N. Korea. Other sections may also include content of the same topic but may be in different forms. For instance, Article C listed in stream section may correspond to a streaming visual content on the same topic C, e.g., the video showing an interview on topic related to the American soldier who cross into N. Korea. In News section, there may also be a link to an online article on the same topic. In this example, if a user clicks on the Article C in the stream section, this expression of interest is ignored by the traditional approach to trending term detection, despite that this user's action should have evidenced the trendiness of trending term C. The same occurs if a user clicks on Article C in section News.

To accurately detect trending terms, the present teaching discloses method and system to capture interests on topics (represented by terms) by exploiting information from diverse sources to detect trending topics. A word or a phrase (a term) representing a topic may be used to identify relevant information from a defined window and leveraged as the basis to analyzing trendiness of the term. The relevant information associated with each term may include search logs from different sources, content items covering the topic(s) represented by the term, as well as engagement metrics determined based on user activities directed to such content items. FIG. 2B depicts an exemplary framework 200 for identifying trending terms based on users' engagement on topics/content, in accordance with an embodiment of the present teaching. In this illustrated embodiment, the framework 200 includes a trending term determiner 240 that dynamically updates a list of trending terms in 110 based on information from various search logs 210, content items in a content database 230 associated with terms to be evaluated, and user/content engagement information 220.

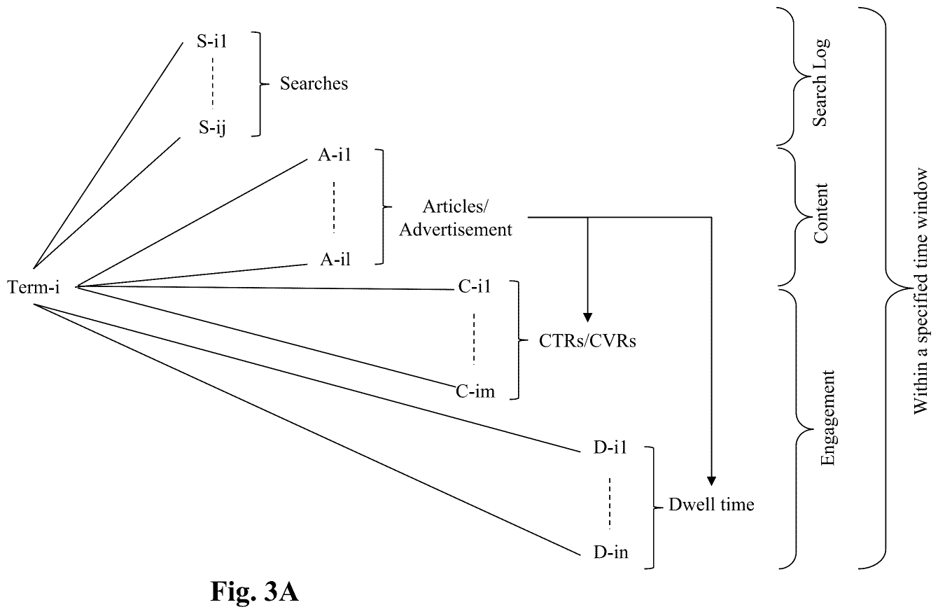

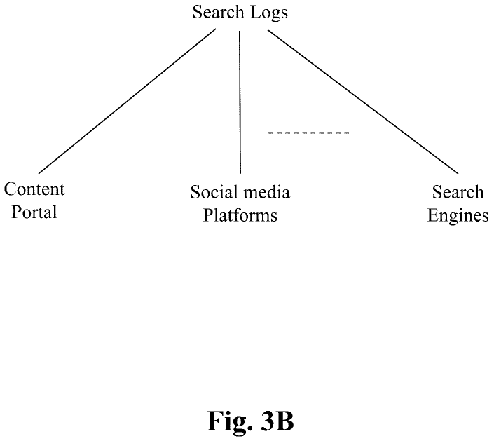

FIG. 3A shows exemplary types of information that may be relevant to a term and may be used for evaluation as to the trendiness of the term, in accordance with an embodiment of the present teaching. As discussed herein, instead of using only information of search logs or clicks on the trending terms, the present teaching discloses to evaluate the trendiness of a term based on a variety range of information relevant to the term. Such relevant information includes, in addition to the explicit expression of interests via searches S-il-S-ij recorded in the search logs and clicks on the term, content on topic(s) represented by the term such as articles and advertisements A-il-Ail, as well as engagement exhibited by users on such content. In some embodiments, the engagement exhibited on content on topics represented by the term may be measured by various measures such as click through rates (CTR) and conversion rates (CVR) C-il-Cim, or dwell time measures D-il-Din indicative of the time that users remained on the content.

In addition to the diverse types of information to be considered in evaluating the trendiness, the present teaching also discloses to collect relevant information for evaluating trendiness of a term from not only a website that provides trending terms but also from different sources on the general online environment where such relevant information is available. That is, such relevant information may be collected from different platforms, different websites, and different applications so that the information that is used to evaluate the trendiness of the term represents accurately the trendiness of the term based on the population instead of designated users of a website. Such relevant information may be obtained via available information provided by different sources or made available by third party information dealers. FIG. 3B illustrates exemplary types of sources of search logs that may be explored for trending term detection, in accordance with an embodiment of the present teaching. As shown, search logs may be generated by different online sources such as content portals, social media platforms, . . . , and search engines. This may be important as users on different online sources may exhibit different interests at different times so that the trendiness of terms evaluated based on a broader understanding of the current interests of the general population may be more accurate.

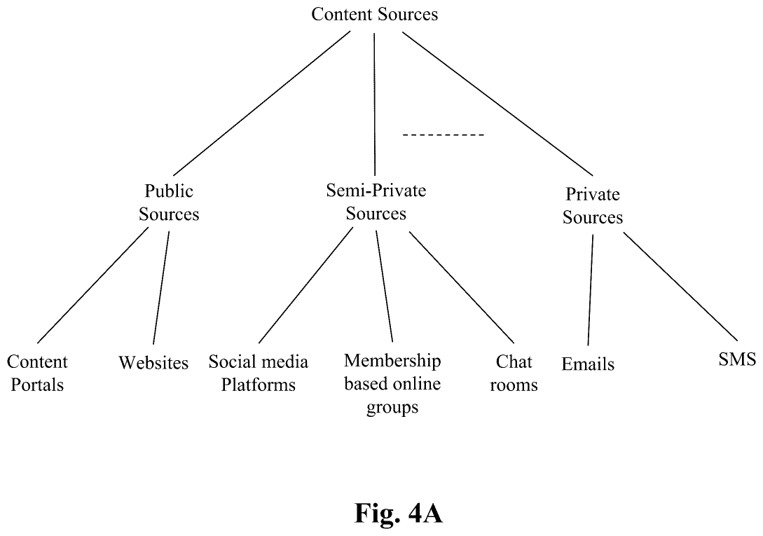

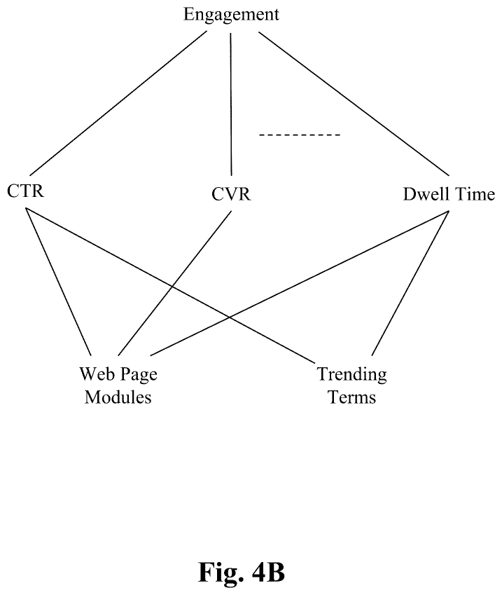

Similarly, content associated with the topic(s) represented by a term to be evaluated for trendiness may be collected from different sources. FIG. 4A illustrates exemplary content sources for content consumed by users that may be explored for trending term evaluation, in accordance with an embodiment of the present teaching. In this illustrated embodiment, content sources from where content of some topics (related to the term) may include public sources, semi-public sources, or even private sources. Public sources may include content made available from different content portals as well as content publicly accessible on different websites. Semi-private sources may include, e.g., different social media platforms, membership based online groups (e.g., various online professional or interest groups), . . . , or chat rooms. In such semi-private sources, users may not only access online articles but also create content directed to discussions, analysis, reviews, etc. and may be relevant to the evaluation of the trendiness of certain topics represented by terms. In general, a party (website, platform, etc.) that is engaged in trending term evaluation may include itself as a source of content including different parts of the operation. For example, a website such as the one illustrated in FIG. 2A has multiple sections operating on the same website and operates to provide a trending term list (TN). Given that, content associated with or accessible via all sections (e.g., Stream section, NTK section, and News section) on topics represented by different terms being evaluated may also be used for trendiness evaluation.

In addition, information from private sources such as email and messages in short message services (SMS) may also reflect the level of interests/focus of users on certain topics. For instance, a service provider may offer services to users in electronic emails so that certain information created by the users on certain topics may also be indicative of the users' interests/focus on such topics and may be considered in evaluating the trendiness of certain terms associated with such topics. Although privacy may come into play when using such information from semi-private and private sources, information may be analyzed as a collective without using any private information of the users participated in creating the relevant content in their communications with others. Content collected from public, semi-private, and private sources may capture a more accurate picture as to what users are interested in a particular period to improve the quality of trendiness evaluation.

As discussed herein, the trendiness evaluation with respect to a term according to the present teaching may also be based on information on engagement of users on content relevant to the term. FIG. 4B shows exemplary types of engagement metrics that may be explored in trending term evaluation, in accordance with an embodiment of the present teaching. As discussed with respect to FIG. 3A, engagement measures may include CTR, CVR, and dwell time and they may be computed with respect to content on relevant topics represented by terms that are being evaluated for trendiness. Some of the measures may be developed based on, e.g., trending terms that are identified. For instance, clicks on trending terms displayed on a webpage may be monitored and such clicks may represent the engagement of users on the trending term. In some situations, such engagement measures may be determined by different parties, including the parties that facilitate the users to access such content or third-party information providers.

The engagement measures may be obtained with respect to user activities exhibited on any section or module on relevant websites or social media platforms. As illustrated in FIG. 2A, there may be different sections on a webpage (“Trending Now” section, “Stream” section, “News” section) and some of them may exhibit items associated with the same term. According to the present teaching, engagement exhibited in any of these webpage modules may be recognized and utilized to estimate the trendiness of the term. In addition, engagement measures may also be obtained based on communications/activities observed external to the webpage where a term is considered. For instance, data indicative of user activities on content associated with a term in other settings, such as semi-private or private channels (not shown in FIG. 4B) may be used to measure engagement with the term. User engagement on content of certain topics may be measured based on, e.g., the frequency of sharing activity (e.g., forwarding an article of a certain topic to a friend) and/or volume of thumbs up from users when an article is posted in a social media group.

In some embodiments, information from different sources may be weighted in trendiness evaluation so that a website's assessment of the trendiness of the terms may be adjusted to fit better to the demographics of the website's users yet still based on an understanding of the interests of a more general population. For instance, when a website operator is evaluating the trendiness of terms to be displayed on its website, sources from where information may be collected for the evaluation may be classified into different types, e.g., the ones similar to the website (e.g., users of substantially similar demographics) and ones that have different characteristics (e.g., users of distinctly different demographical groups). The overall evaluation of the trendiness of a term may be obtained via, e.g., weights placed on different sources. The overall evaluation scheme based on different types of information collected from different sources may be adaptively determined based on the needs of specific applications.

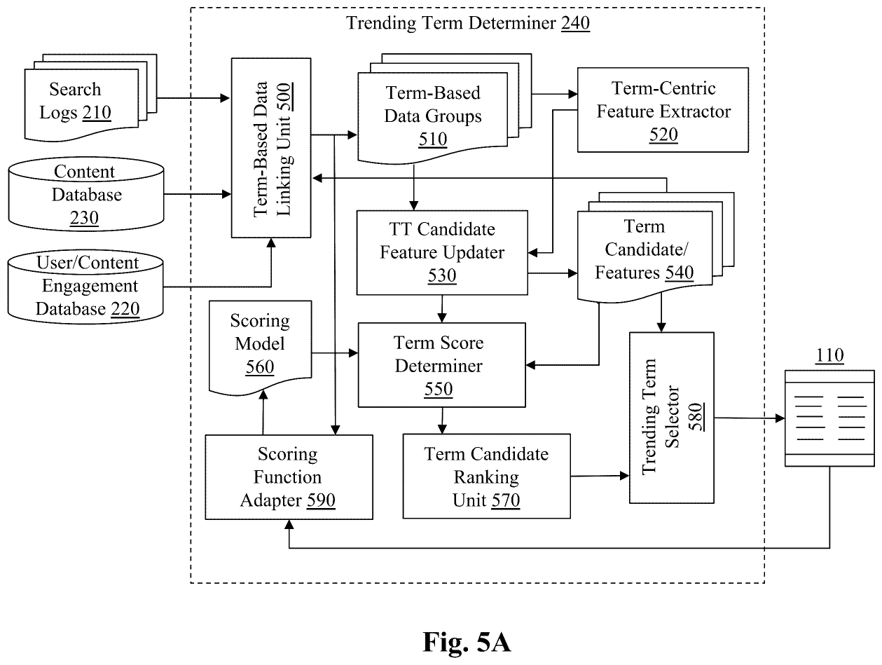

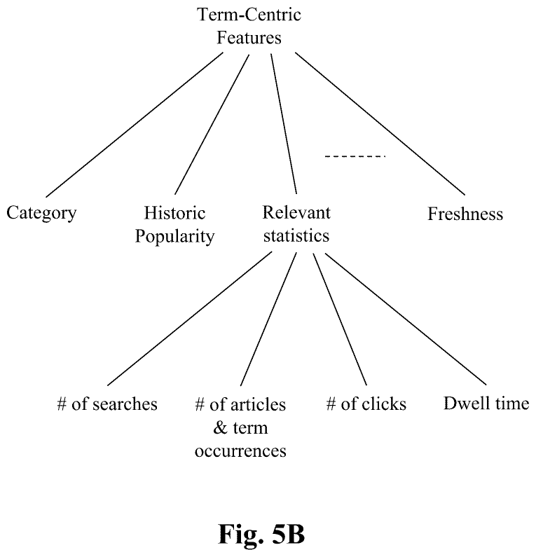

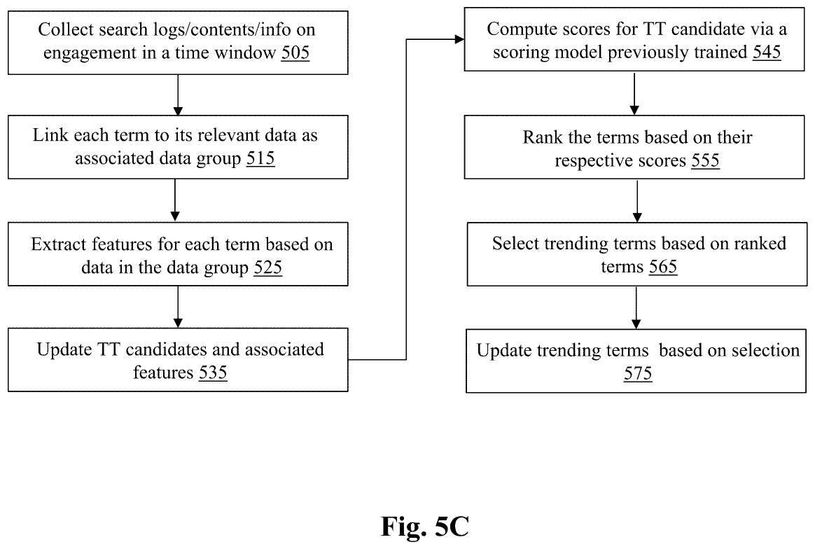

FIG. 5A depicts an exemplary high-level system diagram of the trending term determiner 240, in accordance with an embodiment of the present teaching. As illustrated in FIG. 2B, the trending term determiner 240 takes, with respect to the terms to be evaluated for trendiness, search logs from the search logs 210, relevant content from the content database 230, as well engagement information from the user/content engagement database 220 and then outputs a list of trending terms 110. As discussed herein, due to the time-sensitive nature of trending terms, the inputs used by the trending term determiner 240 for evaluation at any moment are also time sensitive, i.e., they are associated with a period relevant to the evaluation. Based on inputs associated with each term being evaluated, a number of features may be determined and then used to evaluate the trendiness of the term. The illustrated embodiment of the trending term determiner 240 in FIG. 5A includes two parts, one may be for providing dynamically and adaptively updated information (e.g., features associated with each term) to be used to determine the trendiness status of terms to be considered and the other for using updated information adaptively provided based on the real-time situation in a defined window to derive a list of ranked trending terms and then providing some of the ranked trending terms as output 110.

The first part of the trending term determiner 240 comprises a term-based data linking unit 500, a term-centric feature extractor 520, and a trending term (TT) candidate feature updater 530. In this part of the operation, the trending term determiner 240 may maintain a list of term candidates and the features thereof 540, based on which the evaluation is performed. This list of term candidates may be regularly updated so that the list adapts to what is going on in the content space. That is, this list of term candidates may provide a space or scope in which the trending term selection is performed. For this list of terms, features characterizing the term candidates in the list may be determined based on relevant inputs from different sources of databases (210-230) and stored in 540 to facilitate the evaluation of trendiness of such term candidates. In some embodiments, with respect to each of the term candidates in list 540, the term-based data linking unit 500 may access term-based data related to the term candidate from different sources (e.g., 210-230), link such data with the term candidate as a term-based data group as shown in FIG. 3A, and saves the term-based data group in 510. As the inputs related to each term candidate are retrieved with respect to a time window, the features computed therefor may also be only effective within a specified period.

Based on information included in each term-based data group (directed to a corresponding term candidate), the term-centric feature extractor 520 may be provided to compute features associated with the term candidate and the TT candidate feature updater 530 may operate to update the features associated with the term candidate in 540. In some embodiments, as the term candidate may have previously computed features (e.g., determined in a previous period), the currently computed features may be used to replace what had been stored in 540 so that the term-centric features stored in 540 for each of the term candidates are dynamically updated so that they adaptively represent the accurate situation as to the popularity of content associated with the term candidate. When the information stored in 210-230 is continuously collected, the information in 540 may also corresponding updated to support the dynamic detection of trending terms.

FIG. 5B illustrates exemplary types of features that may be computed to characterize the trending situation associated with a term candidate, in accordance with an embodiment of the present teaching. In some embodiments, the features to be computed for a term candidate based on information associated therewith (e.g., the types of information illustrated in FIG. 3A) may be devised to characterize the properties associated with trendiness. For instance, as shown in FIG. 5B, features computed may include at least one category of the content associated with the term, the historic popularity if any, freshness of the content, as well as some relevant statistics such as the number of searches using keywords including the term, the number of articles that include the term and the number of occurrences of the term in such articles, and the engagement statistics such as the number of clicks and/or the dwell time on related articles. In some embodiments, if some content corresponds to advertisements, it is also possible to obtain performance statistics such CVR.

Based on such updated features for term candidates in 540, the second part of the trending term determiner 240 may be provided for select top K term candidates as the trending terms 110. In this illustrated embodiment, the ranking may be based on ranking scores computed for the term candidates in accordance with their updated features stored in 540 computed by the first part of the trending term determiner 240. The second part of the trending term determiner 240 comprises a term score determiner 550, a term candidate ranking unit 570, and a trending term selector 580. The term score determiner 550 is provided to compute a ranking score for each of the term candidates based on a scoring model 560 and send such scores for term candidates to the term candidate ranking unit 570, which is provided to rank the term candidates according to their scores. The ranked term candidates are then sent to the trending term selector 580 so that top K term candidates with, e.g., the highest scores, may then be selected as the trending terms 110. In some embodiments, the score for a term X may be computed as S=G(F(X)), where F(X) represents the set of features for term X and G is a function of the set of features F(X).

FIG. 5C is a flowchart of an exemplary process of the trending term determiner 240, in accordance with an embodiment of the present teaching. As discussed herein, with respect to each of the term candidates, information associated with the term candidate may be collected, at 505, by the term-based linking unit 500, including but may not be limited to, relevant searches using the term from various search logs, content from different sources that include the term or covers a topic represented by the term, as well as information indicative of user engagement with respect to the related content. Such accessed information associated with each term candidate may then be linked, at 515, with the term to generate term-based data group in 510. For each term candidate, the term-centric feature extractor 520 extracts, at 525, features based on the data group generated for the term candidate based on associated information. Such computed features for each term candidate may then be used to update, at 535, the term candidate features for the term candidate in 540. Such features for each term candidate may be updated regularly using a, e.g., moving window in time to make sure that all features satisfy recency condition defined according to some criteria. For instance, the recency may be defined as every day, every 12 hours, etc.

Based on the updated features for term candidates in 540, the term score determiner 550 computes, at 545, a score for each term candidate based on the features extracted for the term. Based on the scores of the term candidates, the term candidate ranking unit 570 ranks, at 555, the term candidates according to the scores therefor. The ranked term candidates may form a sequence of term candidates, arranged based on the scores in a descending order. The trending term selector 580 may then select, at 565, top K term candidates as the trending terms from the ranked list of term candidates based on some predetermined configuration. For instance, the predetermined configuration may specify to select top K terms with the highest scores. Such selected top K term candidates may then be used to update, at 575, the trending terms 110. Upon updating the trending terms, the associated data with respect to the term candidates may continually be collected from different sources and the information in data groups for different term candidates may be accordingly updated with time so that the features as well as scores for these term candidates may also be continually updated. In this manner, the trending terms may be regularly updated in according with the dynamically collected data and adaptively updated features. As the information to be used to evaluate the trendiness according to the present teaching is based on not only users' searches but also content from diverse sources that are associated with the terms under consideration and the users' engagement thereto. The trending terms identified according to the present teaching are therefore accurate in reflecting the trendiness associated with the actual situation.

As discussed herein, the scoring model 560 in FIG. 5A may provide a scoring function for computing a trendiness score for each term candidate based on features associate with the term candidate. In some embodiments, the scoring model 560 may be trained based on training data adaptively collected within a time window. Such training data may include positive and negative samples, e.g., positive samples may correspond to those data groups that are associated with term candidates that are deemed as trending. Other data samples may be labeled as negative. Such training may be dynamically performed based on the data groups associated with term candidates that are continually collected within some time window so that the scoring model 560 is adapted over time.

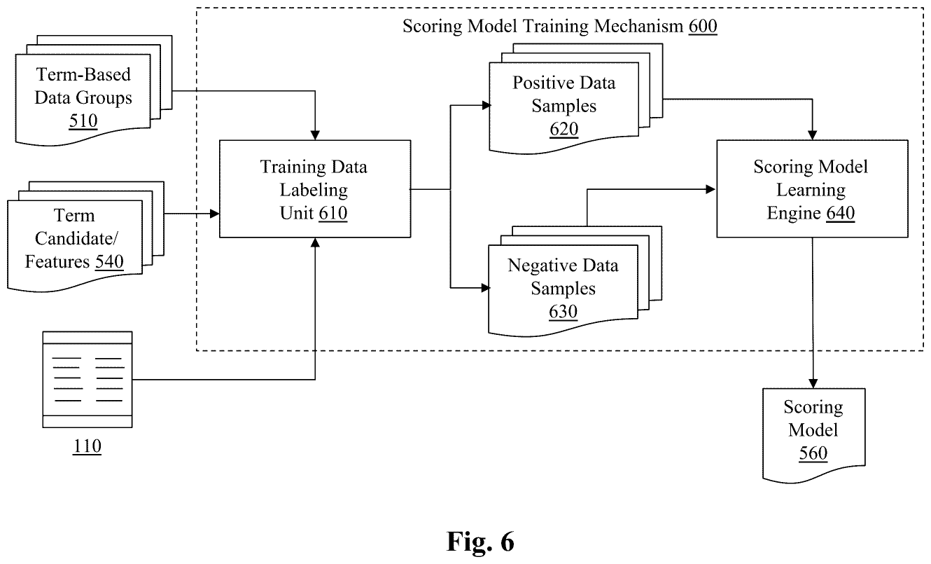

FIG. 6 depicts an exemplary high level system diagram of a scoring model learning mechanism 600, in accordance with an embodiment of the present teaching. In this illustrated embodiment, the scoring model learning mechanism 600 comprises a training data labeling unit 610 and a scoring model learning engine 640, where the training data labeling unit 610 is provided for retrieving corresponding term based data groups that are continually collected for each of the term candidates in 540 and labeling data samples that correspond to trending terms in 100 as positive data samples 620 and others as negative data samples 630. Due to the time sensitivity associated with trending term determination, the data groups for different terms retrieved from 510 for each learning session may be limited within a time window determined based on, e.g., the time of the determination of trending terms. With the labeled training data 620 and 630, the scoring model learning engine 640 may conduct supervised learning to obtain the scoring model 560 as shown in FIG. 6. The scoring model 560 may be updated regularly when new trending terms are update so that new labeled training data may be accordingly generated and used for training. In this manner, the scoring model 560 is adaptive.

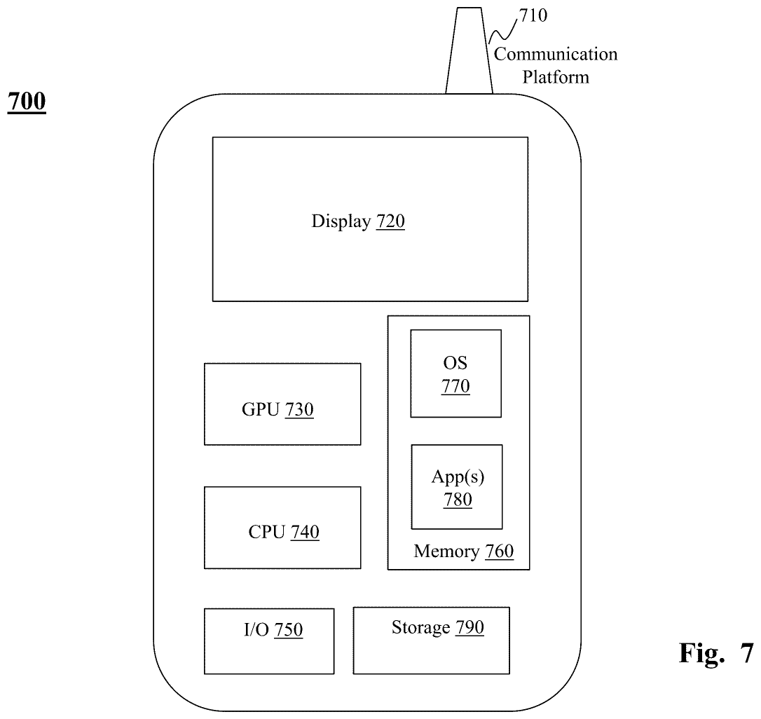

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar therewith to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

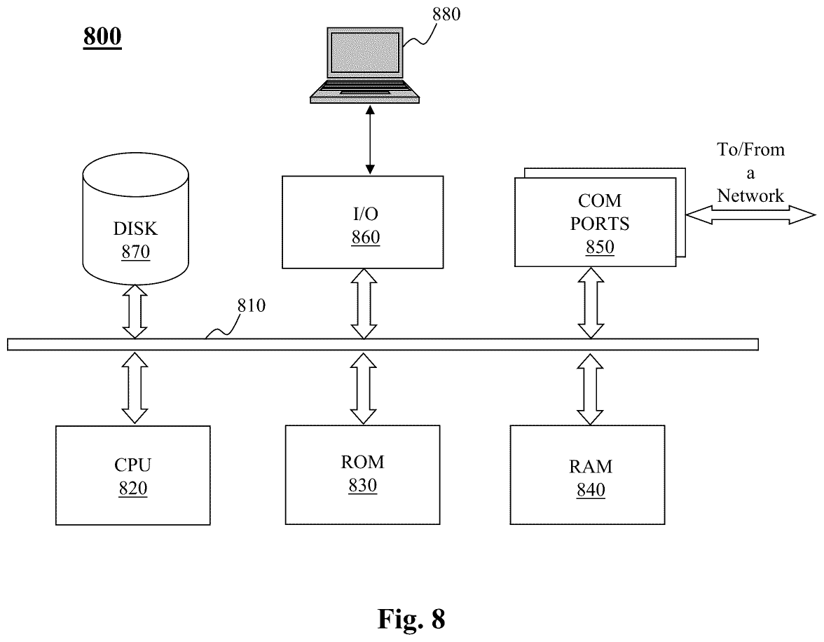

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware or a combination, hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, comprising:
with respect to each of multiple term candidates being evaluated on trendiness,
obtaining information associated with the term candidate in different categories from different sources, wherein the information satisfies a recency requirement defined based on a time period,
linking the term candidate and the information associated therewith to generate a data group for the term candidate,
determining features related to the term candidate based on the data group for the term candidate, and
computing a trendiness score for the term candidate based on the features in accordance with a scoring model; and
selecting trending terms from the multiple term candidates based on the trendiness scores of the multiple term candidates.

2. The method of claim 1, wherein the different categories include:
search logs each of which records searches conducted using different terms;
content covering at least one topic consistent with what the term candidate represents; and
engagement data with respect to the content.

3. The method of claim 2, wherein the engagement data includes one or more of:
click through rate (CTR);
conversion rate (CVR); and
dwell time.

4. The method of claim 1, wherein the different sources include:
public online sources including at least one of a content portal, a search engine, and a website;
semi-private sources including at least one of a social media platform, a membership-based interest group, and a chatroom; and
private sources including at least one of electronic mails and communication messages.

5. The method of claim 1, wherein the features related to the term candidate includes at least one of:
a category classification for the term candidate;
information on historic popularity of the term candidate;
freshness of the term candidate; and
one or more statistics computed based on the information included in the data group of the term candidate.

6. The method of claim 5, wherein the one or more statistics include:
a first metric representing the number of searches conducted during the time period using the term candidate;
a second metric representing the number of articles in the content relating to the term candidate that are available during the time period;
a third metric characterizing the number of occurrences of the term candidate in the articles;
a fourth metric on the number of clicks on content items included in the content; and
a fifth metric indicative of engagement with each content item in the content related to the term candidate accessed during the time period.

7. The method of claim 1, wherein
the scoring model specifies a function of the features related to the term candidate;
the step of selecting trending terms from the multiple term candidates comprises:
ranking the multiple term candidates to generate a ranked list of term candidates according to the respective trendiness scores of the multiple term candidates, and
determining the trending terms from the ranked list based on the ranks of the multiple term candidates, wherein
data groups associated with the determined trending terms are labeled as positive data to generate labeled training data for training the scoring model via supervised learning.

8. A machine readable and non-transitory medium having information recorded thereon, wherein the medium, when read by the machine, causes the machine to perform the following steps:
with respect to each of multiple term candidates being evaluated on trendiness,
obtaining information associated with the term candidate in different categories from different sources, wherein the information satisfies a recency requirement defined based on a time period,
linking the term candidate and the information associated therewith to generate a data group for the term candidate,
determining features related to the term candidate based on the data group for the term candidate, and
computing a trendiness score for the term candidate based on the features in accordance with a scoring model; and
selecting trending terms from the multiple term candidates based on the trendiness scores of the multiple term candidates.

9. The medium of claim 8, wherein the different categories include:
search logs each of which records searches conducted using different terms;
content covering at least one topic consistent with what the term candidate represents; and
engagement data with respect to the content.

10. The medium of claim 9, wherein the engagement data includes one or more of:
click through rate (CTR);
conversion rate (CVR); and
dwell time.

11. The medium of claim 8, wherein the different sources include:
public online sources including at least one of a content portal, a search engine, and a website;
semi-private sources including at least one of a social media platform, a membership-based interest group, and a chatroom; and
private sources including at least one of electronic mails and communication messages.

12. The medium of claim 8, wherein the features related to the term candidate includes at least one of:
a category classification for the term candidate;
information on historic popularity of the term candidate;
freshness of the term candidate; and
one or more statistics computed based on the information included in the data group of the term candidate.

13. The medium of claim 12, wherein the one or more statistics include:
a first metric representing the number of searches conducted during the time period using the term candidate;
a second metric representing the number of articles in the content relating to the term candidate that are available during the time period;
a third metric characterizing the number of occurrences of the term candidate in the articles;
a fourth metric on the number of clicks on content items included in the content; and
a fifth metric indicative of engagement with each content item in the content related to the term candidate accessed during the time period.

14. The medium of claim 8, wherein
the scoring model specifies a function of the features related to the term candidate;
the step of selecting trending terms from the multiple term candidates comprises:
ranking the multiple term candidates to generate a ranked list of term candidates according to the respective trendiness scores of the multiple term candidates, and
determining the trending terms from the ranked list based on the ranks of the multiple term candidates, wherein
data groups associated with the determined trending terms are labeled as positive data to generate labeled training data for training the scoring model via supervised learning.

15. A system, comprising:
a trending term determiner implemented by a processor and configured for, with respect to each of multiple term candidates being evaluated on trendiness,
obtaining information associated with the term candidate in different categories from different sources, wherein the information satisfies a recency requirement defined based on a time period,
linking the term candidate and the information associated therewith to generate a data group for the term candidate,
determining features related to the term candidate based on the data group for the term candidate, and
computing a trendiness score for the term candidate based on the features in accordance with a scoring model; and
selecting trending terms from the multiple term candidates based on the trendiness scores of the multiple term candidates.

16. The system of claim 15, wherein the different categories include:
search logs each of which records searches conducted using different terms;
content covering at least one topic consistent with what the term candidate represents; and
engagement data with respect to the content, including one or more of
click through rate (CTR),
conversion rate (CVR), and
dwell time.

17. The system of claim 15, wherein the different sources include:
public online sources including at least one of a content portal, a search engine, and a website;
semi-private sources including at least one of a social media platform, a membership-based interest group, and a chatroom; and
private sources including at least one of electronic mails and communication messages.

18. The system of claim 15, wherein the features related to the term candidate includes at least one of:
a category classification for the term candidate;
information on historic popularity of the term candidate;
freshness of the term candidate; and
one or more statistics computed based on the information included in the data group of the term candidate.

19. The system of claim 18, wherein the one or more statistics include:
a first metric representing the number of searches conducted during the time period using the term candidate;
a second metric representing the number of articles in the content relating to the term candidate that are available during the time period;
a third metric characterizing the number of occurrences of the term candidate in the articles;
a fourth metric on the number of clicks on content items included in the content; and
a fifth metric indicative of engagement with each content item in the content related to the term candidate accessed during the time period.

20. The system of claim 15, wherein
the scoring model specifies a function of the features related to the term candidate;
the step of selecting trending terms from the multiple term candidates comprises:
ranking the multiple term candidates to generate a ranked list of term candidates according to the respective trendiness scores of the multiple term candidates, and
determining the trending terms from the ranked list based on the ranks of the multiple term candidates, wherein
data groups associated with the determined trending terms are labeled as positive data to generate labeled training data for training the scoring model via supervised learning.
